(19) United States
(12) Patent Application Publication
(10) Pub. No.: US 2010/0315845 A1
(43) Pub. Date: Dec. 16, 2010

(54) POWER SOURCE CIRCUIT AND PROJECTION DISPLAY DEVICE

(75) Inventors: Kazunori Kotani, Nara-city (JP); Kouichi Tsutsumi, Hirakata-city (JP); Takeru Urayama, Osaka-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/795,866

(22) Filed: Jun. 8, 2010

(30) Foreign Application Priority Data
Jun. 16, 2009 (JP) 2009-143607

(51) Int. Cl. H02M 5/45

(52) U.S. Cl. 363/37

(57) ABSTRACT

A power source circuit includes a DC voltage generating section which rectifies and smoothes an input AC voltage to generate a DC voltage; a switching regulator which converts the DC voltage into an AC voltage; a transformer which lowers the AC voltage; a first switch connected between a secondary winding of the transformer, and a load; and a control section which controls on/off of the switch. The control section controls the first switch to turn off the first switch at a time of a waiting mode.

This application claims priority under 35 U.S.C. Section 119 of Japanese Patent Applications No. 2009-143607 filed Jun. 16, 2009, entitled “POWER SOURCE CIRCUIT AND PROJECTION DISPLAY DEVICE”. The disclosures of the above application are incorporated herein by reference.

### BACKGROUND OF THE INVENTION

1. Field of the Invention

The present invention relates to a power source circuit, and a projection display device loaded with the power source circuit.

2. Disclosure of Related Art

Currently, electronic devices are loaded with a power source circuit for converting a commercial alternate-current (AC) voltage into a direct-current (DC) voltage of a predetermined value to supply the DC voltage to circuit sections. Some of the power source circuits are provided with a DC voltage generating section for turning a commercial AC voltage into a DC voltage, a switching regulator for converting the DC voltage generated by the DC voltage generating section into an AC voltage, and a transformer for lowering the converted AC voltage. In the above arrangement, an AC voltage to be outputted from a secondary winding of the transformer after the voltage lowering is smoothed into a DC voltage by a smoothing circuit, and the DC voltage is supplied to a corresponding load section.

Some of the electronic devices have a so-called waiting mode for setting the electronic devices to a waiting state. When an electronic device is in a waiting mode, it is necessary to effectively suppress electric power consumption by a power source circuit.

As an arrangement for suppressing electric power consumption by a power source circuit in a waiting mode, there is proposed an arrangement, wherein a switch is provided anterior to a switching regulator. In the above arrangement, when the electronic device is in a waiting mode, the switch is turned off to cut off a voltage supply to the switching regulator. Thus, the electric power consumption by the circuit sections posterior to the switching regulator is suppressed. This is advantageous in suppressing electric power consumption by the power source circuit when the electronic device is in a waiting mode.

In the above arrangement, on/off control of the switch is performed by a microcomputer. Accordingly, it is necessary to continue electric power supply to the microcomputer even when the electronic device is in a waiting mode. The electric power supply to the microcomputer may be performed by a switching regulator/transformer, and a smoothing circuit for smoothing an output from a secondary winding of the transformer into a DC voltage, which are provided independently for the microcomputer.

In the above arrangement, since the switch is disposed upstream of the transformer, when viewed from a direction along which an electric power is supplied from a commercial power source to load sections, a high voltage is supplied to the switch. In view of this, it is necessary to use a high voltage switch as the switch. Use of an electric power semiconductor device equipped with a resistance as the switch may result in electric power loss and/or an increase in heat generation of the switch, resulting from the electric power supplied to the resistance. In view of the above, it is necessary to additionally provide means for cooling the switch such as a heat releasing fin. In the above arrangement, it is necessary to provide a switching regulator/transformer and a smoothing circuit independently for the microcomputer. Further, in the case where the switch is disposed upstream of the high voltage transformer as described above, it is necessary to secure a relatively large clearance between the switch, and a member adjacent to the switch for a safety measure.

As described above, in the arrangement provided with the switch in the above-described manner, as the size of the switch is increased, the size of the power source circuit is increased. Further, there may occur another problem such as an increase in the size of the power source circuit, and complication of the arrangement of the power source circuit by providing a switch, a microcomputer, and other elements such as cooling means and circuit sections for the switch and the microcomputer.

### SUMMARY OF THE INVENTION

A first aspect of the invention is directed to a power source circuit. The power source circuit according to the first aspect includes a DC voltage generating section which rectifies and smoothes an input AC voltage to generate a DC voltage; a switching regulator which converts the DC voltage into an AC voltage; a transformer which lowers the AC voltage; a first switch connected between a secondary winding of the transformer, and a load; and a control section which controls on/off of the switch. The control section controls the first switch to turn off the first switch at a time of a waiting mode.

In the power source circuit according to the first aspect, since the first switch is disposed downstream of the transformer, it is possible to reduce a voltage to be supplied to the first switch. Thus, a low voltage switch can be used as the first switch. Further, since the first switch is disposed downstream of the low voltage transformer, there is no need of securing a large clearance between the first switch, and a member in the vicinity of the first switch.

A second aspect of the invention is directed to a projection display device. The projection display device according to the second aspect includes a power source circuit; a circuit section which is supplied an electric power by the power source circuit; an optical engine which generates modulated light based on an image signal; and a projection optical system which enlarges and projects the modulated light onto a projection plane. In the above arrangement, the power source circuit includes a DC voltage generating section which rectifies and smoothes an input AC voltage to generate a DC voltage; a switching regulator which converts the DC voltage into an AC voltage; a transformer which lowers the AC voltage; a first switch connected between a secondary winding of the transformer, and a load; and a control section which controls on/off of the switch. The control section controls the first switch to turn off the first switch at a time of a waiting mode.

In the projection display device according to the second aspect, substantially the same function and advantage as those by the power source circuit according to the first aspect are provided.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of a projector embodying the invention.

FIGS. 2A and 2B are diagrams showing arrangements of an optical engine and a projection lens in the embodiment.

FIG. 3 is a diagram showing an arrangement of a power source circuit embodying the invention, and peripheral circuits of the power source circuit.

FIG. 4 is a diagram showing an arrangement of a power factor improving circuit and a second switch in the embodiment.

FIG. 5 is a diagram showing another arrangement of the power source circuit embodying the invention, and peripheral circuits of the power source circuit.

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is an example, wherein a power source circuit of the invention is supplied to a projection display device (hereinafter, called as a “projector”).

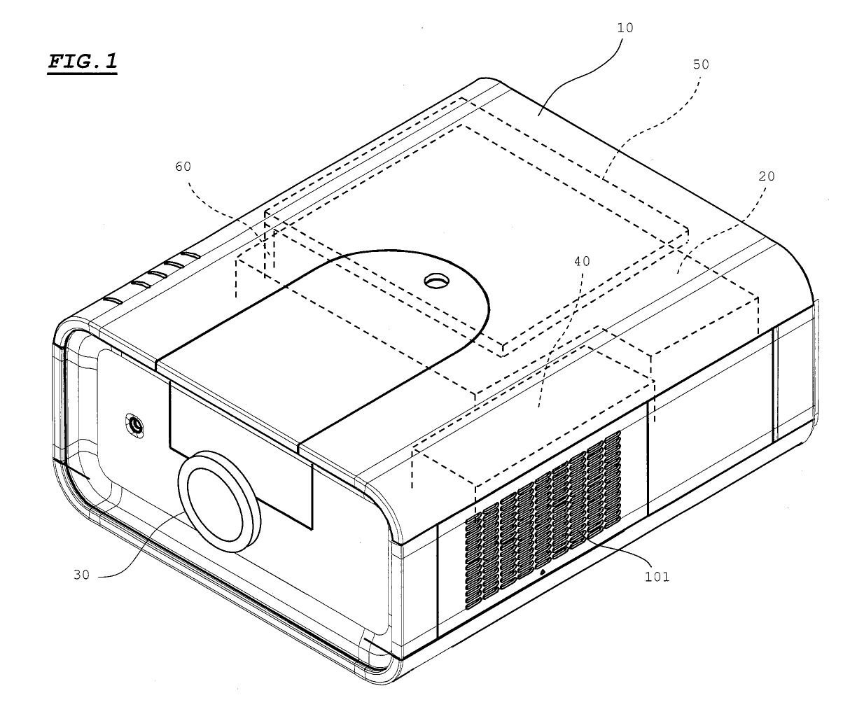

FIG. 1 is a perspective view showing an arrangement of a projector. Referring to FIG. 1, the projector includes a cabinet 10. The cabinet 10 has a substantially rectangular parallelepiped shape with a small size in height direction thereof and a large size in depth direction thereof. The cabinet 10 is formed, on a side wall thereof, with an air inlet 101 for drawing the external air into the cabinet 10.

The cabinet 10 is internally provided with an optical engine 20, a projection lens 30, a cooling device 40, a control unit 50, and a power source unit 60. The optical engine 20 generates image light modulated by an image signal. The projection lens 30 is mounted on the optical engine 20, with a front part of the projection lens 30 being exposed through a front wall of the cabinet 10. Image light generated by the optical engine 20 is enlarged and projected onto a screen plane disposed in front of the projector through the projection lens 30.

The cooling device 40 has a cooling fan and a duct. The cooling device 40 draws in the external air through the air inlet 101 by an operation of the cooling fan, and supplies the external air to intended constituent components such as a light source unit and liquid crystal panels to be described later through the duct. Thus, the intended constituent components are cooled.

The control unit 50 is disposed in a space between the optical engine 20 and a top wall of the cabinet 10. The control unit 50 includes various circuits for driving and controlling the projector, such as a circuit constituting a main control system, a circuit constituting an image/sound signal processing system, and a circuit constituting a LAN communication system, which will be described later. The circuits are mounted on a substrate.

The power source unit 60 is disposed in a space between the optical engine 20 and a side wall of the cabinet 10. The power source unit 60 has a power source circuit, and converts a commercial AC voltage into a DC voltage of a predetermined value to supply the DC voltage to e.g. the circuits in the control unit 50. The detailed configuration of the power source circuit in the power source unit 60 will be described later.

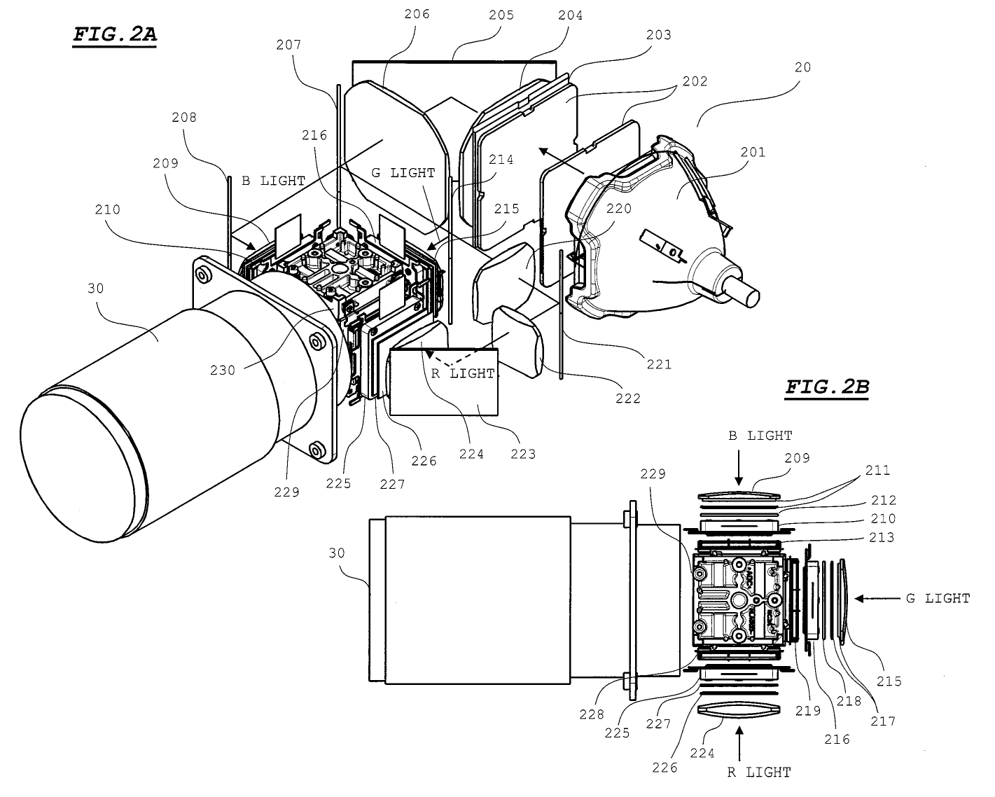

FIGS. 2A and 2B are diagrams showing arrangements of the optical engine 20 and the projection lens 30. FIG. 2A is a perspective view showing the optical engine 20, with a housing thereof being omitted, and the projection lens 30. FIG. 2B is a top plan view showing optical components of the optical engine in the vicinity of the liquid crystal panels, and the projection lens 30.

The optical engine 20 is constituted of various optical components to be described later in the following section in the unillustrated housing.

A light source unit 201 includes a lamp for emitting white light, and a reflector for reflecting the light emitted from the lamp. Examples of the lamp are an ultrahigh pressure mercury lump and a xenon lamp.

Light emitted from the light source unit 201 is transmitted through a fly-eye integrator 202 and a PBS array 203. The fly-eye integrator 202 makes the light amount distribution of light of respective colors to be irradiated onto the liquid crystal panels (to be described later) uniform. The PBS array 203 aligns polarization directions of light directed toward a dichroic mirror 207 in one direction.

Light transmitted through the PBS array 203 is transmitted through a condenser lens 204, has its direction changed by about 90 degrees by a reflection mirror 205, is transmitted through a condenser lens 206, and is entered into the dichroic mirror 207.

The dichroic mirror 207 transmits only light (hereinafter, called as “B light”) in a blue wavelength band, and reflects light (hereinafter, called as “G light”) in a green wavelength band and light (hereinafter, called as “R light”) in a red wavelength band, out of the light entered into the dichroic mirror 207.

B light transmitted through the dichroic mirror 207 is irradiated onto a liquid crystal panel 210 in a proper irradiation state by a lens function by the condenser lens 204, the condenser lens 206, and a condenser lens 209, and reflection by a reflection mirror 208. The liquid crystal panel 210 is driven in accordance with an image signal for B light to modulate the B light depending on a driven state of the liquid crystal panel 210. Two incident-side polarizers 211 and one optical compensator 212 are disposed on the incident side of the liquid crystal panel 210. B light is irradiated onto the liquid crystal panel 210 through the incident-side polarizers 211 and the optical compensator 212. Further, two output-side polarizers 213 are disposed on the output side of the liquid crystal panel 210, and B light emitted from the liquid crystal panel 210 is entered into the output-side polarizers 213.

G light and R light reflected on the dichroic mirror 207 are entered into a dichroic mirror 214. The dichroic mirror 214 reflects the G light and transmits the R light.

G light reflected on the dichroic mirror 214 is irradiated onto a liquid crystal panel 216 in a proper irradiation state by a lens function by the condenser lens 204, the condenser lens 206, and a condenser lens 215. The liquid crystal panel 216 is driven in accordance with an image signal for G light to modulate the G light depending on a driven state of the liquid crystal panel 216. Two incident-side polarizers 217 and one optical compensator 218 are disposed on the incident side of the liquid crystal panel 216. G light is irradiated onto the liquid crystal panel 216 through the incident-side polarizers 217 and the optical compensator 218. Further, two output-side polarizers 219 are disposed on the output side of the liquid crystal panel 216, and G light emitted from the liquid crystal panel 216 is entered into the output-side polarizers 219.

R light transmitted through the dichroic mirror 214 is irradiated onto a liquid crystal panel 225 in a proper irradiation state by a lens function by the condenser lens 204, the condenser lens 206, a condenser lens 222, and relay lenses 220 and 224, and reflection by reflection mirrors 221 and 223. The liquid crystal panel 225 is driven in accordance with an image signal for R light to modulate the R light depending on a driven state of the liquid crystal panel 225. One incident-side polarizer 226 and one optical compensator 227 are disposed on the incident side of the liquid crystal panel 225. R light is irradiated onto the liquid crystal panel 225 through the incident-side polarizer 226 and the optical compensator 227. Further, two output-side polarizers 228 are disposed on the output side of the liquid crystal panel 225, and R light emitted from the liquid crystal panel 225 is entered into the output-side polarizers 228.

B light, G light, and R light modulated by the liquid crystal panels 210, 216, and 225 are transmitted through the output-side polarizers 213, 219, and 228, and entered into a dichroic prism 229. The dichroic prism 229 reflects the B light and the R light, and transmits the G light, out of the B light, the G light, and the R light, to thereby combine the B light, the G light, and the R light. Thus, image light after the color combination is projected toward the projection lens 30 from the dichroic prism 229.

A light modulation element constituting the optical engine 20 may be a reflective liquid crystal panel or an MEMS device, in place of the transmissive liquid crystal panel 210, 216, 225. Further alternatively, the optical engine 20 may be constituted of a single-panel optical system incorporated with one light modulation element and a color wheel, in place of the three-panel optical system incorporated with three light modulation elements as described above.

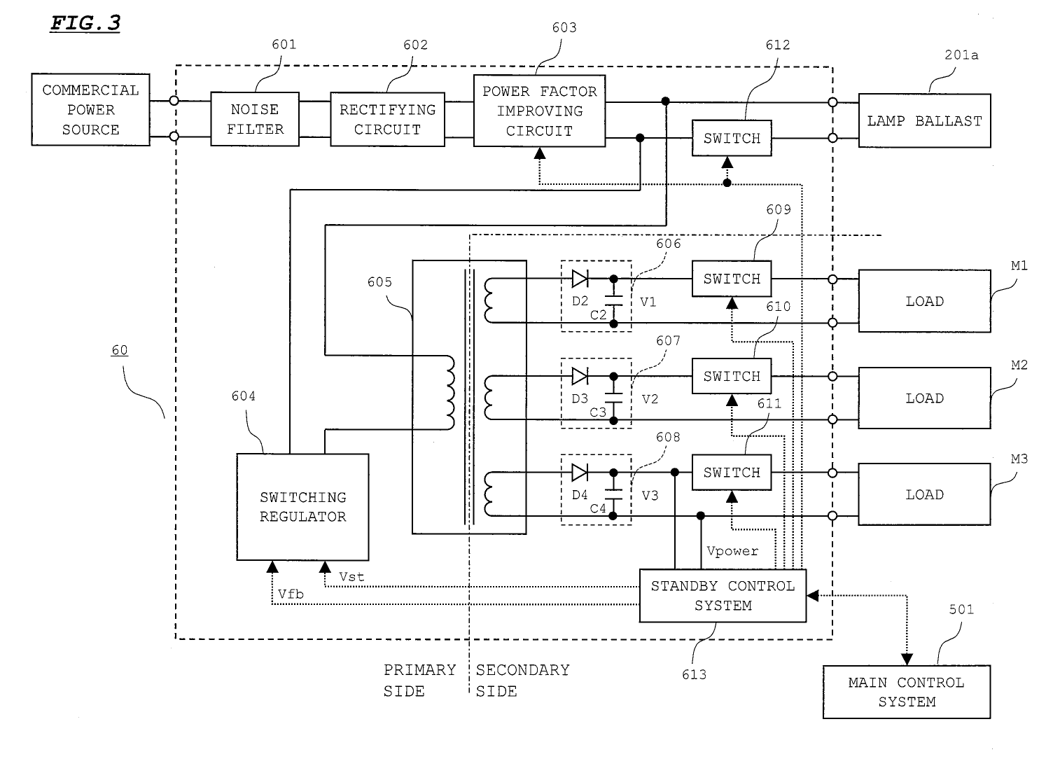

FIG. 3 is a diagram showing an arrangement of the power source circuit and peripheral circuits of the power source circuit.

The power source circuit includes a noise filter 601, a rectifying circuit 602, a power factor improving circuit 603, a switching regulator 604, a transformer 605, smoothing circuits 606, 607, and 608, first switches 609, 610, and 611, a second switch 612, and a standby control system 613.

The noise filter 601 removes noises generated in a commercial AC voltage inputted from a commercial power source, and reduces noises which may flow from a load section to the commercial power source. The rectifying circuit 602 is provided with e.g. a diode bridge, and rectifies full waves of the commercial AC voltage.

The power factor improving circuit 603 rectifies a current waveform into a voltage waveform. The power factor improving circuit 603 also raises the rectified voltage, and smoothes the rectified voltage into a DC voltage. A part of an output voltage Vout from the power factor improving circuit 603 is supplied to a lamp ballast 201a through the second switch 612. The lamp ballast 201a converts a supplied voltage signal into a voltage signal suitable for driving the lamp in the power source unit 201 to drive the lamp. A part of the output voltage Vout from the power factor improving circuit 603 is outputted to the switching regulator 604 and to the transformer 605.

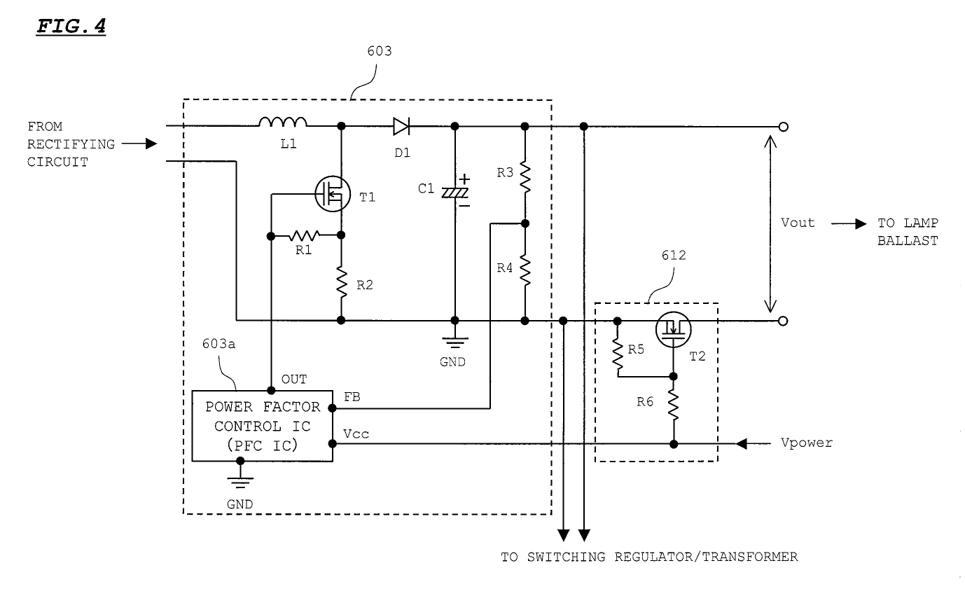

FIG. 4 is a diagram showing the arrangements of the power factor improving circuit 603 and the second switch 612.

The power factor improving circuit 603 includes a coil L1, a diode D1, a transistor (FET: field effect transistor) T1, an electrolytic capacitor C1, resistances R1 through R4, and a power factor control IC 603a.

A voltage divided by the resistances R3 and R4 is inputted to the power factor control IC 603a, as a feedback signal. The power factor control IC 603a controls on/off of the transistor T1 based on the feedback signal. By the on/off control, a current waveform flowing through the coil L1 is rectified into a voltage waveform, in other words, a current waveform is approximated to a sine wave. Thus, the power factor viewed from the side of the commercial power source is improved, and noise failure is prevented.

The voltage inputted to the power factor improving circuit 603 is smoothed into a DC voltage by the electrolytic capacitor C1. In performing the above operation, charge and discharge of electric power in and out of the coil L1 are repeated by on/off control of the transistor T1, and the output voltage Vout is raised by adding the discharged electric power to the electric power in the electrolytic capacitor C1.

A drive signal Vpower is inputted from the standby control system 613 to a terminal Vcc of the power factor control IC 603a. The power factor control IC 603a is driven by the drive signal Vpower to turn on and off the transistor T1. Accordingly, when the output of a drive signal Vpower is suspended, the operation of the power factor control IC 603a is suspended, and the power factor improving function and the voltage raising function by the power factor improving circuit 603 are suspended.

The second switch 612 is constituted of a transistor (FET: field effect transistor) T2, and resistances R5 and R6. Similarly to the power factor control IC 603a, a drive signal Vpower is inputted from the standby control system 613 to the transistor T2. When the drive signal Vpower is inputted, and the transistor T2 is turned on, a portion of the second switch 612 on the side of the power factor improving circuit 603, and the lamp ballast 201a are electrically connected to each other. On the other hand, when the output of a drive signal Vpower is suspended, and the transistor T2 is turned off, the portion of the second switch 612 on the side of the power factor improving circuit 603, and the lamp ballast 201a are electrically disconnected from each other.

Referring back to FIG. 3, the switching regulator 604 converts a DC voltage outputted from the power factor improving circuit 603 into a pulse-like AC voltage by a switching operation at a predetermined frequency to supply the AC voltage to a primary winding of the transformer 605. In an ordinary operation mode, the switching regulator 604 monitors a voltage of the secondary side of the transformer 605, and controls the cycle or duty ratio of an AC voltage to be supplied to the primary winding of the transformer 605 in such a manner that a predetermined voltage is supplied to loads M1 through M3.

The switching regulator 604 has a standby mode function in addition to the ordinary operation mode function. The standby mode is a mode of low output and low electric power loss, and is executed under the control of the standby control system 613 when the projector is brought to a waiting mode i.e. brought to a light load state.

In response to input of a standby signal Vst from the standby control system 613, the switching regulator 604 is switched to a standby mode. When the switching regulator 604 is in a standby mode, a signal indicating a voltage to be supplied to the standby control system 613 is inputted from the standby control system 613 to the switching regulator 604, as a feedback signal Vfb. If it is determined that the supplied voltage lowers a lower limit based on the inputted feedback signal Vfb, the switching regulator 604 performs a switching operation, and starts supplying an AC voltage signal to the primary winding of the transformer 605. Thereafter, if it is determined that the supplied voltage exceeds the lower limit, the switching regulator 64 suspends the supply of an AC voltage signal to the primary winding of the transformer 605. Thus, in the standby mode, the switching regulator 604 intermittently performs supply of an AC voltage by a switching operation. By performing the above operation, as compared with the ordinary operation mode, in the standby mode, the number of switching operations is reduced, and electric power consumption by the switching regulator 604 is suppressed.

The transformer 605 is provided with the primary winding, and secondary windings of three kinds. The transformer 605 lowers an AC voltage converted by the switching regulator 604 to an AC voltage of a value depending on each of the secondary windings.

The smoothing circuits 606, 607, and 608 have diode D2, D3, and D4, and capacitors C2, C3, and C4 to rectify and smooth respective corresponding AC voltages into DC voltages V1, V2, and V3, respectively.

Similarly to the second switch 612, the first switches 609, 610, and 611 are each constituted of a field effect transistor (FET). The first switches 609, 610, and 611 are disposed on the secondary side of the transformer 605, and a voltage to be supplied to the first switches 609, 610, and 611 is significantly small, as compared with a voltage to be supplied to the second switch 612. Accordingly, a small-sized transistor is used for the first switches 609, 610, and 611.

Drive signals Vpower are respectively inputted from the standby control system 613 to the first switches 609, 610, and 611. When the drive signals Vpower are inputted from the standby control system 613, the first switches 609, 610, and 611 are turned on, and portions of the first switches 609, 610, and 611 on the side of the smoothing circuits 606, 607, and 608, and the loads M1, M2, and M3 are respectively and electrically connected to each other, whereby a voltage is allowed to be supplied to the loads M1, M2, and M3. On the other hand, when the output of drive signals Vpower is suspended, the first switches 609, 610, and 611 are turned off, and the portions of the first switches 609, 610, and 611 on the side of the smoothing circuits 606, 607, and 608, and the loads M1, M2, and M3 are respectively and electrically disconnected from each other. The load M1 is a circuit of relatively high electric power consumption, such as drivers for the liquid crystal panels and the cooling fan. The loads M2 and M3 are circuits of relatively low electric power consumption, such as the circuits constituting the main control system, the LAN communication system, and the image/sound signal processing system.

The standby control system 613 is constituted of a CPU, a memory, a key switch, and a remote controller receiving circuit. The standby control system 613 controls on/off of the power factor improving circuit 603, the first switches 609, 610, and 611, and the second switch 612 by drive signals Vpower. Further, the standby control system 613 controls the switching regulator 604 by a standby signal Vst and a feedback signal Vfb. The projector of the embodiment is configured in such a manner that input signals from the key switch and the remote controller receiving circuit constituting the standby control system 613 are also inputted to a main control system 501.

Out of three DC voltage supply lines, as electric power supply lines to the standby control system 613, a supply line having a voltage necessary for the standby control system 613, for instance, a supply line of the DC voltage V3 is branched from a portion between the smoothing circuit 608 and the first switch 611. Accordingly, even if the first switch 611 is turned off, the output voltage V3 is supplied to the standby control system 613.

The standby control system 613 is connected to the main control system 501. The main control system 501 is constituted of a CPU and a memory. The main control system 501 controls e.g. drivers for the image/sound signal processing system, the LAN communication system, the lamp ballast 201a, and the cooling fan, when the projector is in a running mode. The image/sound signal processing system is a system for executing a function of e.g. applying processing such as resolution conversion or gamma correction to an image signal inputted from an external device, generating drive signals for the liquid crystal panels 210, 216, and 225, and outputting the drive signals to the drivers for the liquid crystal panels. The LAN communication system is a system for communicating data with an external device through an LAN.

In the above arrangement, when the projector is in a running mode, drive signals Vpower are outputted from the standby control system 613 to the first switches 609 through 611, the second switch 612, and the power factor improving IC 603a. Then, the first switches 609 through 611, and the second switch 612 are turned on to allow a voltage to be supplied to the loads M1 through M3 (such as the drivers for the main control system, the image/sound signal processing system, the LAN communication system, the liquid crystal panels, and the cooling fan), and to the lamp ballast 201a; and the power factor control IC 603a is operated to improve the power factor by the power factor improving circuit 603. In performing the above operation, a standby signal Vst is not outputted from the standby control system 613, and the switching regulator 604 is operated in an ordinary operation mode.

Thus, when the projector is in a running mode, an image projecting operation is executed under the control of the main control system 501.

When a power source switch, as an exemplified key switch, is turned off by a user, the main control system 501 performs a sequence of terminating the image projecting operation. For instance, after the light from the light source unit 201 is turned off, the cooling fan is driven for a certain period until the light source unit 201 is cooled.

Upon completion of the operation terminating sequence, the projector is shifted to a waiting mode. When the projector is shifted to a waiting mode, a signal for shifting the processing from the running mode to the waiting mode is outputted from the main control system 501 to the standby control system 613.

Then, when the projector is in the waiting mode, the standby control system 613 executes either one of a high electric power saving mode and a low electric power saving mode. For instance, a user is allowed to set either one of the electric power saving modes in advance, using an OSD (on-screen display).

In the case where the high electric power saving mode is set as the electric power saving mode, output of drive signals Vpower from the standby control system 613 to the first switches 609 through 611, the second switch 612, and the power factor control IC 603a is suspended. Then, the first switches 609 through 611, and the second switch 612 are turned off to disconnect the circuit to the loads M1 through M3, and to the lamp ballast 201a; and the power factor control IC 603a is turned off to turn off the power factor improving circuit 603. Further, a standby signal Vst is outputted from the standby control system 613 to operate the switching regulator 604 in a standby mode.

Thus, the first switches 609 through 611, and the second switch 612 are turned off to thereby reduce electric power consumption of the loads M1 through M3 and the lamp ballast 201a at the time of suspending the operations of the loads M1 through M3 and the lamp ballast 201a. Further, the operation of the power factor control IC 603a is suspended to thereby reduce electric power consumption of the power factor improving circuit 603. Further, electric power consumption of the switching regulator 604 is also reduced. Thus, the overall electric power consumption of the projector in a waiting mode is remarkably reduced.

On the other hand, in the case where the low electric power saving mode is set as the electric power saving mode, output of drive signals Vpower from the standby control system 613 to the first switch 609 corresponding to the load M1, the second switch 612, and the power factor control IC 603a is suspended. Then, the first switch 609 and the second switch 612 are turned off to disconnect the circuit to the load M1 (drivers for the liquid crystal panels and the cooling fan), and to the lamp ballast 201a; and the power factor control IC 603a is turned off to turn off the power factor improving circuit 603. Further, a standby signal Vst is outputted from the standby control system 613 to operate the switching regulator 604 in a standby mode. In the low electric power saving mode, however, drive signals Vpower are continued to be outputted from the standby control system 613 to the first switches 610 and 611 corresponding to the loads M2 and M3. Accordingly, the first switches 610 and 611 are kept in an on-state, and a voltage is allowed to be supplied to the loads M2 and M3 (such as the main control system).

The main control system 501 and the LAN communication system are operable by performing the above operation. Accordingly, it is possible to perform a part of processing by the main control system, such as a remote control operation of the projector through the LAN communication, even if the projector is in a waiting mode. Further, since the first switch 609 and the second switch 612 are turned off, the power factor control IC 603a is turned off, and the switching regulator 604 is brought to a standby mode, the overall electric power consumption of the projector is reduced to some extent, although the electric power saving effect is not as high as the high electric power saving mode.

In the low electric power saving mode, there is a case that electric power consumption is unduly increased depending on a circuit configuration of the main control system 501 or the LAN communication system, despite that the switching regulator 604 is in a standby mode. In such a case, it is necessary to operate the switching regulator 604 in an ordinary operation mode, despite that the projector is in a waiting mode. The power factor improving circuit 603 can be turned off, because noise failure is negligibly small in a low electric power consumption state. Accordingly, an increase in electric power consumption may result in noise failure. In view of this, it is desirable to keep the power factor improving circuit 603 in an on-state, without turning off the power factor control IC 603a.

In the above arrangement, the first switch 609 corresponding to the load M1, which is not required in LAN communication in the low electric power saving mode, is turned off to perform LAN communication when the projector is in a waiting mode. Alternatively, if the load M2 is an only load required for LAN communication, the first switch 611 as well as the first switch 609 may be turned off in the low electric power saving mode. Specifically, in the low electric power saving mode, at least one of the first switches 609 through 611 connected to a load, which is not required to be operated in the low electric power saving mode, may be turned off.

When the projector is in a waiting mode, in response to turning on of the power source switch by a user, for instance, in the high electric power saving mode, drive signals Vpower are outputted from the standby control system 613. Then, the first switches 609 through 611, and the second switch 612 are turned on to allow a voltage to be supplied to the loads M1 through M3 and to the lamp ballast 201a; and the power factor control IC 603a is operated. Further, output of a standby signal Vst from the standby control system 613 is suspended to operate the switching regulator 604 in an ordinary operation mode.

Thus, the projector is shifted from a waiting mode to a running mode, and an image projection operation is started under the control of the main control system 501.

As described above, since the first switches 609 through 611 are disposed downstream of the transformer 605, it is possible to reduce a voltage to be supplied to the first switches 609 through 611. Accordingly, it is possible to use a low voltage switch as the first switches 609 through 611 to thereby miniaturize the power source circuit. Further, it is possible to reduce electric power loss and heat generation resulting from the first switches 609 through 611. Accordingly, there is no need of additionally providing cooling means such as a heat releasing fin. This is advantageous in suppressing an increase in the size of the power source circuit, and complication of the arrangement of the power source circuit. Furthermore, since the first switches 609 through 611 are disposed downstream of the low voltage transformer, there is no need of securing a large clearance between the first switches 609 through 611, and a member in the vicinity of the first switches 609 through 611. Thus, it is possible to suppress an increase in the space due to provision of the first switches 609 through 611.

In the embodiment, the electric power supply line to the standby control system 613 is branched from a portion between the secondary winding of the transformer 605, and the first switch 611. Accordingly, there is no need of providing e.g. a switching regulator/transformer independently for supplying an electric power to the standby control system 613. This is advantageous in suppressing complication of the arrangement of the power source circuit, and an increase in the size of the power source circuit.

Further, in the embodiment, the switching regulator 604 is selectively set to the ordinary operation mode, and the standby mode of low output and low electric power loss, as compared with the ordinary operation mode. The switching regulator 604 is controlled and set to the standby mode, when the projector is in a waiting mode. Accordingly, it is possible to suppress electric power consumption of the switching regulator 604 when the projector is in a waiting mode. This is advantageous in suppressing electric power consumption of the power source circuit.

Furthermore, in the embodiment, since the power factor improving circuit 603 is turned off when the projector is in a waiting mode, it is possible to reduce electric power consumption of the power factor improving circuit 603 when the projector is in a waiting mode. This is advantageous in suppressing electric power consumption of the power source circuit.

Furthermore, in the embodiment, the second switch 612 is connected to a portion between the power factor improving circuit 603 and the lamp ballast 201a, and the second switch 612 is turned off when the projector is in a waiting mode. Accordingly, it is possible to supply a high voltage which is not lowered by the transformer 605 to the lamp ballast 201a, and smoothly disconnect the lamp ballast 201a from the power source circuit when the projector is in a waiting mode. Thus, the arrangement is more advantageous in suppressing electric power consumption of the power source circuit.

<Modification>

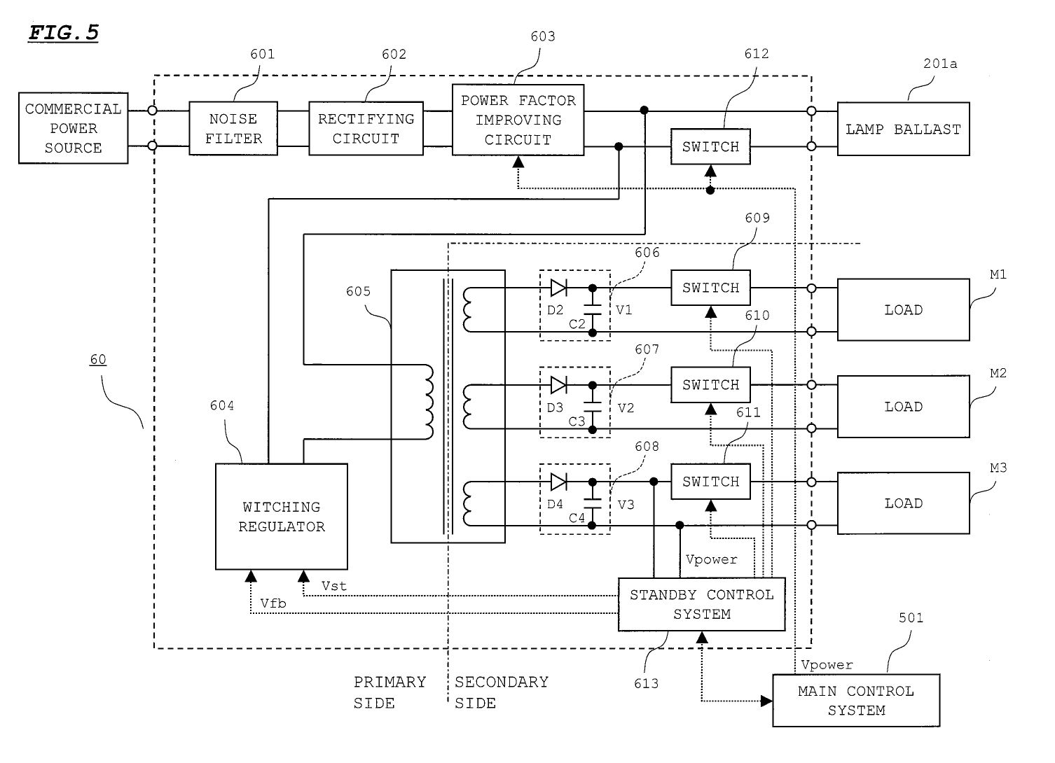

FIG. 5 is a diagram showing a modification of the power source circuit and peripheral circuits of the power source circuit.

The modification is different from the embodiment in that drive signals Vpower are outputted from a main control system 501 to a second switch 612 and to a power factor improving circuit 603 (a power factor control IC 603a).

In the modification, when the projector is in a running mode, drive signals Vpower are outputted from the main control system 501 to thereby turn on the second switch 612 and turn on the power factor improving circuit 603. Then, when the projector is shifted from the running mode to a waiting mode, upon completion of an operation terminating sequence in the running mode, the main control system 501 suspends output of drive signals Vpower. By performing the above operation, the second switch 612 is turned off to disconnect the circuit to a lamp ballast 201a, and the power factor improving circuit 603 is turned off.

Further, when the projector is shifted from a waiting mode to a running mode, the first switches 609 through 611 are turned on by the standby control system 613, and a voltage is supplied to the main control system 501. Upon supply of the voltage to the main control system 501, drive signals Vpower are outputted from the main control system 501. Then, the second switch 612 is turned on to allow a voltage to be supplied to the lamp ballast 201a, and the power factor improving circuit 603 is operated.

The modification is also advantageous in providing substantially the same function and advantage as in the embodiment.

<Other Modifications>

The embodiment of the invention may be modified in various ways other than the above. For instance, in the embodiment, field effect transistors are used as the first switches 609 through 611, and the second switch 612. Alternatively, for instance, another electric power semiconductor device such as a thyristor or a bipolar transistor may be used. Further, a mechanical relay may be used as the second switch 612.

Further alternatively, the inventive power source circuit may be supplied to an electronic device such as a television receiver, a video recorder, or an air conditioner, other than the projector.

The embodiment of the invention may be changed or modified in various ways as necessary, as far as such changes and modifications do not depart from the scope of the claims of the invention hereinafter defined.

What is claimed is:

1. A power source circuit comprising:
a DC voltage generating section which rectifies and smoothes an input AC voltage to generate a DC voltage;
a switching regulator which converts the DC voltage into an AC voltage;
a transformer which lowers the AC voltage;
a first switch connected between a secondary winding of the transformer, and a load; and
a control section which controls on/off of the switch, wherein
the control section controls the first switch to turn off the first switch at a time of a waiting mode.

2. The power source circuit according to claim 1, wherein
an electric power supply line to the control section is branched from a portion between the secondary winding of the transformer, and the first switch.

3. The power source circuit according to claim 1, wherein
the switching regulator is selectively set to a first operation mode, and a second operation mode of low output and low electric power loss, as compared with the first operation mode, and
the control section controls the switching regulator to set the switching regulator to the second operation mode at the time of the waiting mode.

4. The power source circuit according to claim 1, wherein
the DC voltage generating section includes a power factor improving circuit, and
the control section controls the power factor improving circuit to turn off the power factor improving circuit at the time of the waiting mode.

5. The power source circuit according to claim 1, further comprising:
a second switch connected between the DC voltage generating section, and the load, wherein
the control section controls the second switch to turn off the second switch at the time of the waiting mode.

6. A projection display device comprising:
a power source circuit;
a circuit section which is supplied an electric power by the power source circuit;
an optical engine which generates modulated light based on an image signal; and
a projection optical system which enlarges and projects the modulated light onto a projection plane, wherein
the power source circuit includes:
a DC voltage generating section which rectifies and smoothes an input AC voltage to generate a DC voltage;
a switching regulator which converts the DC voltage into an AC voltage;
a transformer which lowers the AC voltage;
a first switch connected between a secondary winding of the transformer, and a load; and
a control section which controls on/off of the switch, wherein
the control section controls the first switch to turn off the first switch at a time of a waiting mode.

7. The projection display device according to claim 6, wherein
an electric power supply line to the control section is branched from a portion between the secondary winding of the transformer, and the first switch.

8. The projection display device according to claim 6, wherein
the switching regulator is selectively set to a first operation mode, and a second operation mode of low output and low electric power loss, as compared with the first operation mode, and
the control section controls the switching regulator to set the switching regulator to the second operation mode at the time of the waiting mode.

9. The projection display device according to claim 6, wherein
the DC voltage generating section includes a power factor improving circuit, and
the control section controls the power factor improving circuit to turn off the power factor improving circuit at the time of the waiting mode.

10. The projection display device according to claim 6, further comprising:
a second switch connected between the DC voltage generating section, and the load, wherein
the control section controls the second switch to turn off the second switch at the time of the waiting mode.
